(19) United States
(12) Patent Application Publication
(10) Pub. No.: US 2008/0026705 A1
(43) Pub. Date: Jan. 31, 2008

(54) Digital Broadcast Receiving Antenna Apparatus and Movable Body Incorporating the Same

(75) Inventor: Ken Asami, Saitama-ken (JP)

Correspondence Address: CARRIER BLACKMAN AND ASSOCIATES, 24101 NOVI ROAD, SUITE 100, NOVI, MI, 48375, US

(73) Assignee: Honda Motor Co., Ltd., Minato-ku (JP)

(21) Appl. No.: 11/631,739

(22) PCT Filed: Jul. 12, 2005
(86) PCT No.: PCT/JP05/12802

§ 371 Date: Jan. 5, 2007

(30) Foreign Application Priority Data
Jul. 15, 2004 (JP) 2004-209108

(51) Int. Cl. H04B 1/034

(52) U.S. Cl. 455/99

(57) ABSTRACT

A digital broadcast receiving antenna apparatus that, even when applied to a movable body, such as automobile or the like, can exhibit a high level of receiving characteristic. For this purpose, digital broadcast wave signals, which are received by four antennas, for example, disposed in rear quarter glasses and so tuned as to have nondirectivity, are in-phase combined by two in-phase combining circuits. The in-phase combined signals are then diversity combined by a diversity combining circuit constituting a receiver. In this way, a high level of receiving characteristic of digital broadcast waves can be obtained.

### TECHNICAL FIELD

The present invention relates to an antenna apparatus for receiving digital broadcasts according to a diversity reception scheme, with glass antennas mounted onto glass panes of a mobile body movable over a land surface, e.g., a vehicle such as an automobile, as well as to a mobile body incorporating such an antenna apparatus.

### BACKGROUND ART

Generally, when radio broadcasts or television broadcasts are received by a mobile body such as an automobile while it is running, the received field intensity of the received radio waves varies depending on the site, position, speed, and direction of the mobile body. In order to reduce deterioration in reception characteristics due to variations in the intensity of the received field intensity, which is peculiar to the mobile body, there has widely been used a so-called antenna switching diversity technology, wherein plural reception antennas mounted on an automobile are connected to a switch, and the switch is operated to select an output from a reception antenna with good reception sensitivity.

Recently, test broadcasts using digital broadcasting waves, rather than analog broadcasting waves, as television broadcasting waves, have begun for effectively utilizing frequencies. For receiving digital broadcasting waves, there has been disclosed a digital broadcast receiver that adds the signals received by a plurality of antennas using an adding means, and supplies the added signal to a tuner (see Patent Document 1).

Patent Document 1: Japanese Laid-Open Patent Publication No. 10-70517 (FIG. 1)

### DISCLOSURE OF THE INVENTION

The conventional antenna switching diversity technology is effective to receive analog broadcast waves, and can continuously keep a non-directional high-level reception capability by selecting an antenna-received wave with a high field intensity, and demodulating the wave with a tuner.

However, if the antenna switching diversity technology is applied to the reception of digital broadcast waves, then a phase shift of each antenna-received wave, which is caused upon switching between antenna-received waves, needs to be corrected, and a correcting circuit therefor cannot easily be realized. Receiving digital broadcast waves with upper and lower antennas of a single antenna assembly, and using the received digital broadcast waves in the antenna switching diversity technology, requires a high antenna gain, which also is difficult to actualize. The directivity of a glass antenna mounted on a windshield glass pane, even if it is optimally tuned at a certain site, varies greatly due to a pillar of the automobile located at another site. It is difficult to provide a single, completely non-directional antenna.

Patent Document 1 referred to above, which reveals a digital broadcast receiver for adding signals received by a plurality of antennas using an adding means and supplying the added signal to a tuner, discloses that the electric power received by the receiver increases and the reception area is widened. However, Patent Document 1 simply shows a circuit block diagram, wherein outputs from a plurality of antennas are added by an adding means, and this document discloses nothing whatsoever about any specific layouts of the antennas or specific details of the adding means. Furthermore, nothing is disclosed about glass antennas.

The present invention has been made in view of the above drawbacks. It is an object of the present invention to provide an antenna apparatus for receiving digital broadcasts, which is applied to a mobile body movable over a land surface, thereby to achieve high-level reception characteristics, as well as to provide a mobile body incorporating such an antenna apparatus.

Another object of the present invention is to provide an antenna apparatus for receiving digital broadcasts, which should preferably be applied as an antenna apparatus for receiving digital broadcasts according to a diversity reception scheme, with a glass antenna mounted on a windshield glass pane of a mobile body movable over a land surface, e.g., a vehicle such as an automobile, as well as to provide a mobile body incorporating such an antenna apparatus.

According to the present invention, an antenna apparatus for receiving digital broadcasts has a plurality of antennas mounted on a mobile body 12 movable over a land surface, a plurality of in-phase combining means for combining signals of at least two of digital broadcast waves received by the antennas, in phase with each other, and a diversity combining means, which is supplied with a plurality of digital broadcast wave signals combined by the in-phase combining means, and which performs diversity combination on the supplied digital broadcast wave signals.

Since the in-phase combining means combines signals of at least two of digital broadcast waves received by the antennas in phase with each other, and the diversity combining means performs diversity combination on the combined signals, therefore, high-level reception characteristics are provided for the digital broadcast waves.

Preferably, the antennas for receiving the digital broadcast waves to be combined in phase with each other by the in-phase combining means are arranged so as to be non-directional. Ideally, if non-directional antennas are provided for receiving radio waves uniformly in all directions through 360°, then the antenna apparatus can efficiently receive radio waves regardless of the direction of the mobile body.

The antenna apparatus thus constructed should preferably be incorporated in a mobile body movable over a land surface, e.g., roads, lakes and swamps, sand areas, etc., particularly an automobile or the like, which changes its running direction relatively frequently.

If the antenna apparatus is used as a diversity reception glass antenna apparatus for use on a vehicle such as an automobile or the like having confronting window glass panes on opposite sides thereof, then the antennas include two antennas mounted on each of the window glass panes. Signals from feeders of the respective antennas on each of the window panes are combined in phase with each other by one of the in-phase combining means, and the combined signals from the in-phase combining means based on the signals from the antennas on the window panes are supplied to the diversity combining means, which performs diversity combination of the signals. Accordingly, the antenna apparatus can produce a high-level reception output.

If the antenna apparatus is used as a diversity reception glass antenna apparatus for use on a vehicle such as an automobile or the like having confronting window glass panes on opposite sides thereof and a rear windshield glass pane, then the antennas include an antenna mounted on each of the window glass panes and two antennas mounted on the rear windshield glass pane. Digital broadcast wave signals from adjacent feeders of the antenna on one of the window glass panes and one of the antennas on the rear windshield glass pane are combined in phase with each other by one of the in-phase combining means, digital broadcast wave signals from adjacent feeders of the antenna on the other of the window glass panes and the other of the antennas on the rear windshield glass pane are combined in phase with each other by the other of the in-phase combining means, and the combined signals from the in-phase combining means are supplied to the diversity combining means, which performs diversity combination of the signals.

The four antennas for in-phase combination and diversity combination, which are mounted on the glass panes of the vehicle such as an automobile or the like, should preferably be arranged as non-directional antennas (omnidirectional antennas) for receiving radio waves in all directions through 360° by complementing the directivities of the four antennas. As a result, the antenna gain produced by the four antennas is increased for enabling high-level reception characteristics after diversity combination.

According to the present invention, inasmuch as the in-phase combining means combines signals of at least two of digital broadcast waves received by the antennas in phase with each other, and the diversity combining means performs diversity combination on the combined signals, therefore, high-level reception characteristics can be provided for digital broadcast waves on a mobile body that is movable over a land surface.

According to the present invention, furthermore, at least two of the digital broadcast waves received by the antennas disposed on glass panes of a mobile body that is movable over a land surface, e.g., a vehicle such as an automobile or the like, are combined in phase with each other, and the combined signals are combined by the diversity combining means for performing diversity combination of the signals. Consequently, non-directional and high-level reception characteristics for digital broadcast waves are provided on the vehicle.

### BRIEF DESCRIPTION OF THE DRAWINGS

FIG. 1 is a schematic plan view of a vehicle such as an automobile, which forms a mobile body according to an embodiment of the present invention, and which incorporates an antenna apparatus for receiving digital broadcasts according to an embodiment of the present invention;

FIG. 2 is a view showing an in-phase combining circuit and a connection layout of input and output terminals thereof;

FIG. 3 is a view showing an in-phase combining circuit to which two conductors of different lengths are connected from antennas, and a connection layout of input and output terminals thereof;

FIG. 4 is a plan view illustrative of the directivity of glass antennas;

FIG. 5 is a view illustrative of the directivity combined by the in-phase combining circuit, at the time that the directivity is tuned as shown in FIG. 4; and

FIG. 6 is a schematic plan view showing an antenna apparatus for receiving digital broadcasts according to another embodiment of the present invention.

### BEST MODE FOR CARRYING OUT THE INVENTION

Embodiments of the present invention shall be described below with reference to the drawings.

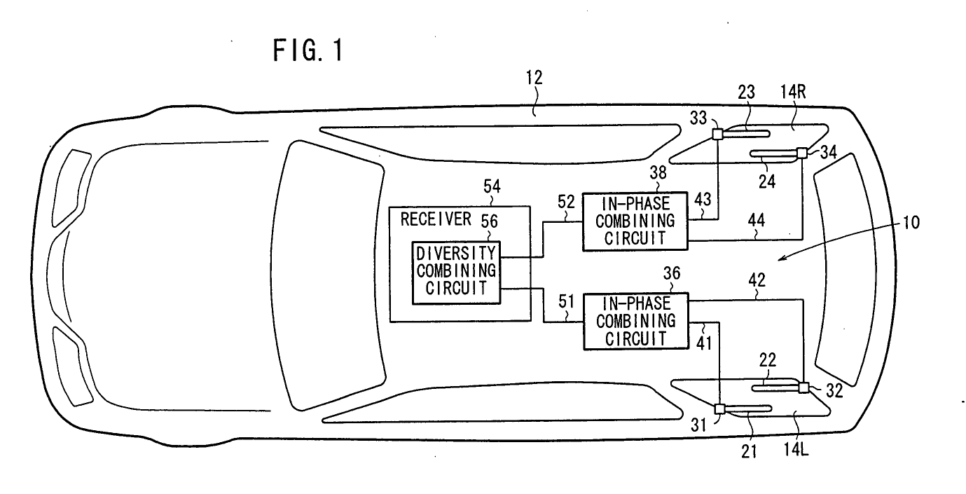

FIG. 1 is a schematic plan view of a vehicle 12, such as an automobile, which forms a mobile body according to an embodiment of the present invention, and further which incorporates an antenna apparatus 10 for receiving digital broadcasts according to an embodiment of the present invention.

As shown in FIG. 1, the antenna apparatus 10 for receiving digital broadcasts, which is based on an OFDM principle, has two UHF antennas 21, 22 and two UHF antennas 23, 24 mounted as glass antennas, respectively on left and right rear quarter glass panes (windshield glass panes confronting each other on opposite sides of the vehicle 12) 14L, 14R, in confronting relation to each other transversely on opposite sides of the vehicle 12.

The four antennas 21 through 24 comprise printed wires or conductive wires embedded in laminated glass intermediate layers of the left and right rear quarter glass panes 14L, 14R, but not limited to the rear quarter glass panes 14L, 14R. The antennas 21 through 24 may be mounted on windshield glass panes on the left and right sides, or on a rear windshield glass pane, as described later, depending on the vehicle type.

The four antennas 21 through 24 are constructed as non-directional antennas whose layout and shape are tuned to complement their directivities, so as to provide fully circumferential directivity for receiving radio waves uniformly in all directions through 360°.

Signals of digital broadcast waves output from the left two antennas 21, 22 are brought into phase with each other by feeders 31, 32, and supplied through conductive wires 41, 42 to an in-phase combining circuit 36 that serves as an in-phase combining means, which combines the signals in phase with each other. At the same time, signals of digital broadcast waves output from the right two antennas 23, 24 are brought into phase with each other by feeders 33, 34, and supplied through conductive wires 43, 44 to an in-phase combining circuit 38, which combines the signals in phase with each other.

The two digital broadcast wave signals, which have been combined by the in-phase combining circuits 36, 38, are supplied through respective conductive wires 51, 52 to a diversity combining circuit 56 that serves as a diversity combining means of a receiver 54. The diversity combining circuit 56 combines the supplied two digital broadcast wave signals according to diversity combination. The diversity-combined digital broadcast wave signal is demodulated by a demodulator, not shown, and also supplied to a display monitor, not shown, which reproduces video and audio data.

The conductive wires 41 through 44 that interconnect the feeders 31 through 34 of the antennas 21 through 24 and the in-phase combining circuits 36, 38, as well as the conductive wires 51, 52 that interconnect the in-phase combining circuits 36, 38 and the diversity combining circuit 56, may comprise coaxial wires, or striplines or microstrips provided on printed wiring boards.

The in-phase combining circuits 36, 38 and the diversity combining circuit 56 may further be provided on printed wiring boards with components mounted thereon.

One of the in-phase combining circuits 36, and its connection layout of input and output terminals, is identical to the other in-phase combining circuit 38, and its connection layout of input and output terminals. The in-phase combining circuit 36, and its connection layout of input and output terminals, shall be described below by way of example.

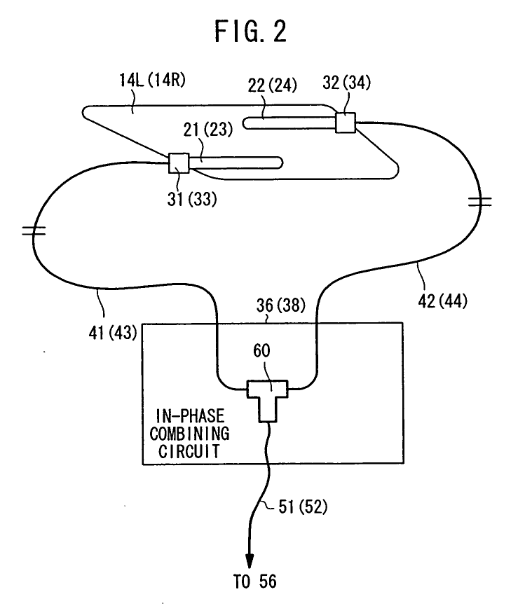

FIG. 2 shows the in-phase combining circuit 36, and a connection layout of input and output terminals thereof. The conductive wires 41, 42 from the feeders 31, 32 of the antennas 21, 22 have equal lengths. The conductive wires 41, 42 have signal lines and ground lines directly connected, or matched and connected, by a connector 60 such as a Y-shaped coaxial connector or the like that is fixed to an attachment plate. The connector 60 is connected to the diversity combining circuit 56 by the conductive wire 51.

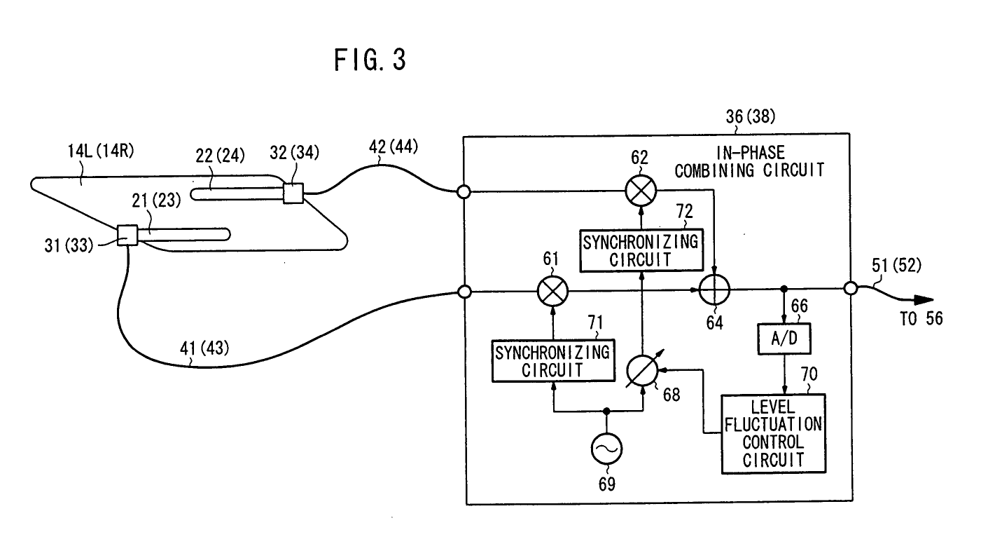

FIG. 3 shows the in-phase combining circuit 36 and a connection layout of input and output terminals thereof, where the conductive wires 41, 42 have different lengths because of a layout limitation.

The in-phase combining circuit 36 shown in FIG. 3 includes frequency converters 61, 62 that convert the digital broadcast wave signals, which are output from the antennas 21, 22 and supplied through the conductive wires 41, 42 of different lengths, into digital broadcast wave signals having an intermediate frequency (IF). The IF digital broadcast wave signals are output from the frequency converters 61, 62 and added to each other by an adder 64. The sum IF digital broadcast wave signal output from the adder 64 is feedback-controlled so that the its level, i.e., the level of the signal to be supplied through the conductive wire 51 to the diversity combining circuit 56, will be maximized.

For feedback control, the sum IF digital broadcast wave signal output from the adder 64 is converted into digital data by an A/D converter 66, wherein a phase shift caused by a phase controller (phase shifter) 68 is automatically adjusted by a level fluctuation control circuit 70, depending on the level of the digital data.

A local oscillator 69 produces a local signal, which is supplied through a synchronizing circuit 71 to the frequency converter 61, and also through the phase controller 68 and a synchronizing circuit 72, to the frequency converter 62.

The phase controller 68 is adjusted by the level fluctuation control circuit 70 so that the level of the digital data output from the A/D converter 66 will be maximized. Since the in-phase combining circuit 36 is constructed as shown in FIG. 3, the lengths of the conductive wires 41 through 44 from the feeders 31 through 34 to the in-phase combining circuits 36, 38 are subject to less strict limitations, which facilitates practical mounting details including wire and circuit board layouts and positions.

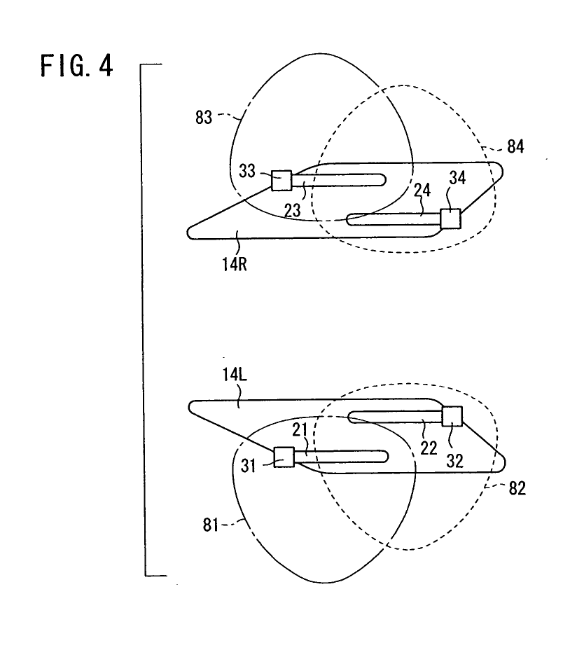

FIG. 4 is a plan view illustrative of the directivity of glass antennas. As shown in FIG. 4, the antennas 21, 22 and the antennas 23, 24 are tuned so as to provide respective directivities 81 through 84 that are curved outwardly of the vehicle 12.

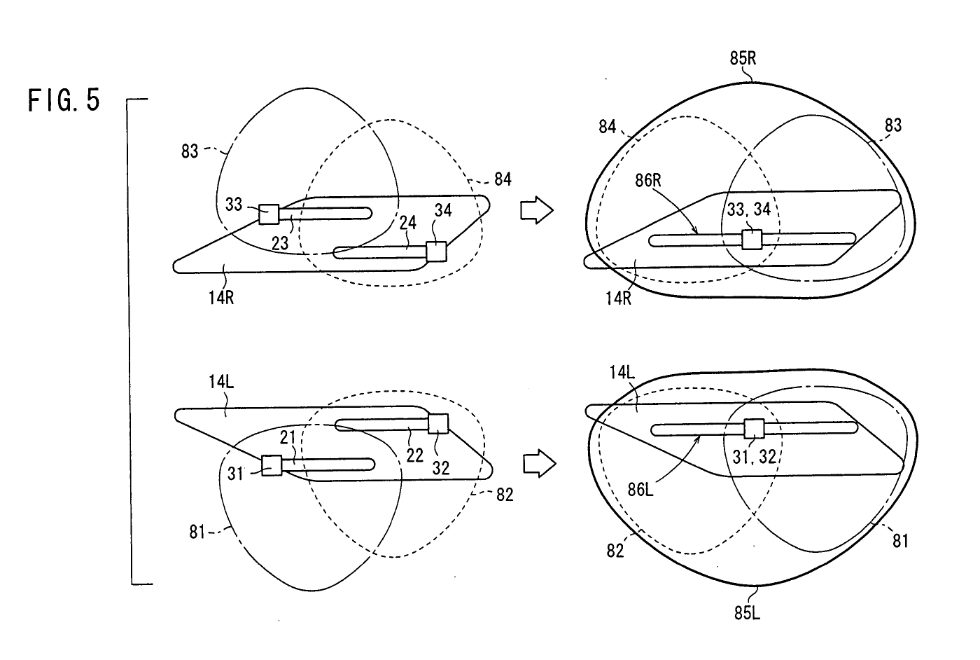

FIG. 5 schematically shows directivities 85L, 85R that are combined by the in-phase combining circuits 36, 38 from the directivities 81 through 84, which are tuned as shown in FIG. 4. The directivity 85L combined by the in-phase combining circuit 36 for the left glass antenna is equivalent to a tuned directivity provided in all directions (circumferentially through 180°) on the outer left side of the vehicle 12 by a single antenna 86L, which is a combination of the antennas 21, 22 with an equivalent feeder 31, 32 in a common position therebetween. Similarly, the directivity 85R combined by the in-phase combining circuit 38 for the right glass antenna is equivalent to a tuned directivity provided in all directions (circumferentially through 180°) on the outer right side of the vehicle 12 by a single antenna 86R, which is a combination of the antennas 23, 24 with an equivalent feeder 33, 34 in a common position therebetween.

Therefore, the four antennas 21 through 24 on the rear quarter glass panes 14L, 14R of the vehicle 12 provide non-directional antennas having respective directivities 85L, 85R for receiving radio waves uniformly in all directions through 360°, wherein the directivities 85L, 85R are provided by complementing the directivities 81 through 84 of the antennas 21 through 24 with the in-phase combining circuits 36, 38.

The combined signals produced by the respective in-phase combining circuits 36, 38 are supplied to the diversity combining circuit 56 of the receiver 54.

The receiver 54 with the diversity combining circuit 56 performs diversity combination on digital broadcast waves, which have been dispersed by reflections or the like during propagation and received by the two equivalent antennas 86L, 86R, whose directivities 85L, 85R are provided on respective opposite sides of the vehicle 12, as shown in FIG. 5. Therefore, the receiver 54 has high-level reception characteristics at all times, even when the vehicle 12 changes its site, position, speed, and direction.

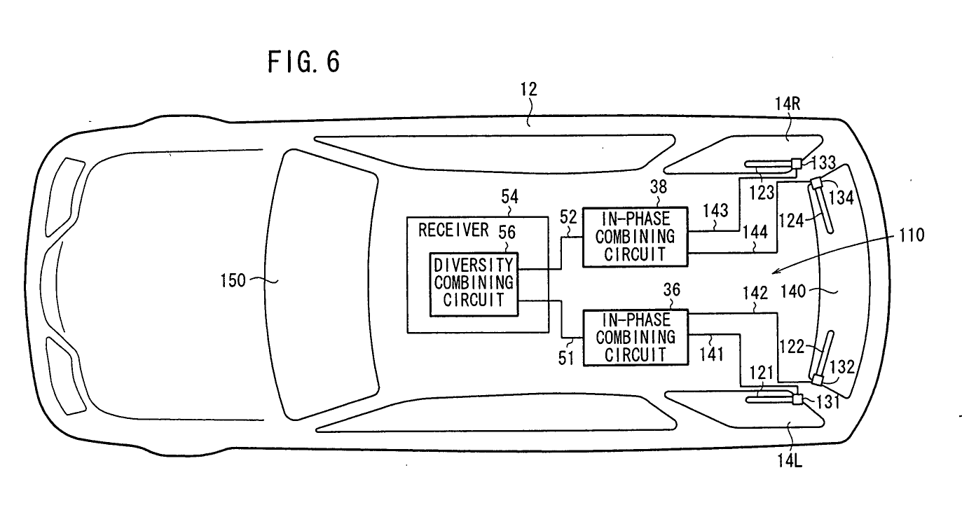

FIG. 6 shows in plan an antenna apparatus 110 for receiving digital broadcasts according to another embodiment of the present invention. As shown in FIG. 6, the antenna apparatus 110 comprises two antennas 121, 123 mounted respectively on left and right rear quarter glass panes 14L, 14R and having respective feeders 131, 133, together with two antennas 122, 124 mounted on respective opposite side regions of a rear windshield glass pane 140 and having respective feeders 132, 134.

On the left side of the vehicle 12, digital broadcast wave signals received by the antenna 121 on the left quarter glass pane 14L and the antenna 122 on the rear windshield glass pane 140, which are positionally close to each other, are supplied through conductive wires 141, 142 to the in-phase combining circuit 36. On the right side of the vehicle 12, digital broadcast wave signals received by the antenna 123 on the right quarter glass pane 14R and the antenna 124 on the rear windshield glass pane 140, which are positionally close to each other, are supplied through conductive wires 143, 144 to the in-phase combining circuit 38.

The digital broadcast wave signals, which are combined by the in-phase combining circuits 36, 38, are further combined by the diversity combining circuit 56. The two antennas 121, 123 on the respective rear quarter glass panes 14L, 14R on opposite sides of the vehicle 12, and the two antennas 122, 124 on the rear windshield glass pane 140, are tuned as shown in FIG. 4 so as to provide high-level reception characteristics at all times, as with the embodiment shown in FIG. 1 (FIG. 5).

If the layout permits, or if transparent electrodes are employed, then antennas may be mounted on a front windshield glass pane 150.

With the antenna apparatus 10, 110 shown in FIGS. 1 and 6 for receiving digital broadcasts, as described above, the four antennas 21 through 24 and 121 through 124, which are mounted on glass panes of the vehicle 12, are optimally tuned so as to be non-directional. The two antennas {(21, 22), (23, 24)}, {(121, 122), (123, 124)} are combined with each other by the feeders {(31, 32), (33, 34)}, {(131, 132), (133, 134)}, and the combined two antennas 86L, 86R have respective output terminals connected to the diversity combining circuit 56, in order to perform optimum diversity combination on the digital broadcast wave signals. Accordingly, antenna gains are increased for increased reception sensitivity of digital broadcast waves.

The four antennas are combined by the feeders, through the in-phase combining circuits 36, 38, in order to provide two equivalent antennas 86L, 86R. Consequently, the number of complex and expensive diversity combining circuits is reduced in half, i.e., a single diversity combining circuit 56 is employed. As a result, the cost of the receiver 54 can be lowered.

The present invention is not limited to the above embodiments, but may take various arrangements, based on the descriptions of the present specification.

1. An antenna apparatus for receiving digital broadcasts, comprising:
a plurality of antennas mounted on a mobile body movable over a land surface;
a plurality of in-phase combining means for combining signals of at least two of digital broadcast waves received by said antennas, in phase with each other; and
diversity combining means for being supplied with a plurality of digital broadcast wave signals combined by said in-phase combining means, and for performing diversity combination on the supplied digital broadcast wave signals.

2. An antenna apparatus according to claim 1, wherein said antennas for receiving the digital broadcast waves to be combined in phase with each other by said in-phase combining means are arranged so as to be non-directional.

3. A mobile body movable over a land surface, incorporating therein an antenna apparatus for receiving digital broadcasts according to claim 1.

4. An antenna apparatus according to claim 1, wherein said mobile body comprises a vehicle having confronting window glass panes on opposite sides thereof, said antennas including two antennas mounted on each of said window glass panes, and wherein signals from feeders of the respective antennas on each of said window panes are combined in phase with each other by one of said in-phase combining means, and combined signals from said in-phase combining means based on the signals from the antennas on said window panes are supplied to said diversity combining means for diversity combination.

5. An antenna apparatus according to claim 1, wherein said mobile body comprises a vehicle having confronting window glass panes on opposite sides thereof and a rear windshield glass pane, said antennas including an antenna mounted on each of said window glass panes and two antennas mounted on said rear windshield glass pane, and wherein digital broadcast wave signals from adjacent feeders of the antenna on one of said window glass panes and one of the antennas on said rear windshield glass pane are combined in phase with each other by one of said in-phase combining means, digital broadcast wave signals from adjacent feeders of the antenna on the other of said window glass panes and the other of the antennas on said rear windshield glass pane are combined in phase with each other by the other of said in-phase combining means, and combined signals from said in-phase combining means are supplied to said diversity combining means for diversity combination.

6. A mobile body movable over a land surface, incorporating therein an antenna apparatus for receiving digital broadcasts according to claim 2.
